(19) United States
(12) Patent Application Publication
(10) Pub. No.: US 2005/0169389 A1
(43) Pub. Date: Aug. 4, 2005

(54) Increased user capacity ultra wideband (UWB) signal formatting scheme

(76) Inventor: Gerald R. Fischer, Playa Del Rey, CA (US)

Correspondence Address: Connie M. Thousand;Northrop Grumman Space & Mission Systems Corp., Space Technology, One Space Park, Bldg. E1/2041, Redondo Beach, CA, 90278, US

(21) Appl. No.: 10/773,137

(22) Filed: Feb. 4, 2004

(51) Int. Cl. H04L 27/00

(52) U.S. Cl. 375/259

(57) ABSTRACT

A method for ultra wideband (UWB) communication in which UWB pulses are transmitted to multiple users during a single time interval used in a time division multiple access (TDMA) system. In one disclosed form of the invention, multiple subintervals or sub-divisions of each TDMA time interval are allocated to the transmission of multiple UWB pulses representing multiple data bits to be transmitted to the same user. Multiple subintervals of the same TDMA time interval are allocated to the reception of multiple return UWB pulses from the same user. In another disclosed form of the invention, multiple subintervals of each TDMA time interval are allocated to the transmission of multiple UWB pulses representing data bits to be transmitted to multiple respective users. Multiple subdivisions in the same TDMA time interval are allocated to the reception of return UWB pulses from the respective multiple users.

### BACKGROUND OF THE INVENTION

The present invention relates generally to communication systems using ultra wideband (UWB) pulses and, more particularly, to techniques for increasing user capacity in UWB transmitters. Communication by UWB pulses, sometimes referred to as impulse radio communication, is a known but not yet widely used technique. The term “impulse radio” is generally used to describe UWB systems in which there is no carrier signal contained within the pulses. The term UWB may also be applied to systems in which the transmitted pulses are bursts of a radio frequency carrier signal. An extremely narrow electromagnetic pulse inherently contains a wide band of frequencies. Adding information to a stream of UWB pulses may be effected by pulse position modulation, wherein the instantaneous value of an information signal sample is used to modulate the position in time of a UWB pulse. At a more fundamental level, UWB pulses may also be modulated by their presence or absence in an otherwise periodic train of pulses. These principles are known in the technical literature and are conveniently summarized in U.S. Pat. No. 5,677,927, issued to Fullerton et al.

Because UWB communication utilizes a large band of the frequency spectrum, it offers the advantages of security and resistance to jamming. Because UWB communication utilizes bandwidth inefficiently, governmental authorization of its use has been limited to relatively low powers. UWB communication, even at low powers, offers the advantages of a relatively long range, the ability to penetrate walls of buildings, and low transceiver cost. However, communication by UWB pulses has some practical limitations, such as the difficulties inherent in applying the technique to multiple users. For example, one possible application of UWB communication systems is for supplying Internet and television connection to homes, as an alternative to coaxial cable, optical fiber cable, or satellite dish communication. UWB communication is ideal for this purpose because it permits the transmission of information at high data rates, using relatively low cost transceivers and processors at user sites. One inherent shortcoming of UWB communication systems, however, is that they allow only one user to receive unique information during any given time interval. The Fullerton et al. patent (U.S. Pat. No. 5,677,927) teaches the use of subcarriers of different frequencies or different waveforms to add channelization to impulse radio signals used in UWB transmission.

There is a need for a UWB signal transmission format that will allow multiple users, such as multiple home users of wireless Internet or television services, to access a centrally located transmitter/receiver station with minimum interference between users. Due to the wideband character of UWB transmission, frequency division multiplexing is not possible. A simple form of time division multiplexing, in which users are serviced sequentially, is one possible solution.

One major problem occurs when multiple users are positioned at significantly different distances from the centrally located transmitter/receiver, such that information returned from the users cannot be equalized for all users. For instance, suppose the central station transmits a signal to User A and some time later transmits a signal to User B. Suppose further that the signal transmitted to User A is subject to multipath effects, wherein the originally transmitted signal is reflected from buildings or other objects, such that User A receives multiple versions of the signal, transmitted over different paths and subject to different time delays. User A generates multiple return signals in response. These multiple return signals may also be subject to multipath effects and may interfere with either the transmitter signal sent to User B, or with return signals sent by User B. It is apparent, therefore, that having multiple users share a common centrally located transmitter/receiver can lead to significant signal interference problems.

Another major problem associated with the use of a single central transmitter/receiver is that it may be difficult to send out sufficiently frequent transmissions to each user to achieve a desirably low data latency. It will be appreciated from the foregoing that there is a need for a UWB signal formatting scheme that overcomes or minimizes these difficulties. The present invention is directed to this end.

### BRIEF SUMMARY OF THE INVENTION

The present invention resides in a method, for use in an ultra wideband (UWB) communication system, for communicating binary data as a sequence of UWB pulses using time division multiple access (TDMA). In accordance with one embodiment of the invention, the method comprises the steps of allocating a succession of TDMA time intervals to respective users; transmitting a first user pulse in a first TDMA time interval; receiving a first user return pulse in the first TDMA time interval; transmitting a second and other user pulses in a second and subsequent respective TDMA time intervals; and receiving a second user return pulse in the second TDMA time interval, and other user pulses in subsequent respective TDMA time intervals. Each TDMA time interval is selected to be at least twice the propagation time needed to transmit data to a user, to minimize interference effects.

In accordance with another aspect of the invention, the method comprises the steps of allocating a succession of TDMA time intervals to respective users; transmitting multiple data pulses in a first TDMA time interval; and receiving multiple return data pulses later in the same TDMA time interval. The multiple data pulses are transmitted to a first user and the multiple return data pulses are received from the same first user. The method may further comprise transmitting multiple data pulses to a second user in a second TDMA time interval and receiving multiple return data pulses from the second user in the second TDMA time interval. Preferably, each TDMA time interval is selected to be at least twice the time needed to transmit data to a user, to minimize interference effects.

In another variant of the invention, the method comprises the steps of allocating subintervals of each TDMA time interval to different users; transmitting multiple data pulses in a first TDMA time interval, wherein the data pulses are addressed to separate multiple users; and receiving multiple return data pulses later in the same TDMA time interval. The return data pulses are received from separate multiple users. The method may further comprise the steps of transmitting multiple data pulses to multiple users in a second TDMA time interval; and receiving multiple return data pulses later in the same second TDMA time interval. Preferably, each TDMA time interval is selected to be at least twice the time needed to transmit data to a user, to minimize interference effects.

It will be appreciated from the foregoing that the present invention provides a significant advance in the field of UWB communication systems. In particular, the invention provides for transmitting data pulses to multiple users and receiving return data pulses from the multiple users, by subdividing each TDMA time interval into subintervals, each of which accommodates a separate UWB pulse. Therefore, multiple data bits can be transmitted or received in a single TDMA time interval. Other aspects and advantages of the invention will become apparent from the following more detailed description, taken in conjunction with the accompanying drawings.

### BRIEF DESCRIPTION OF THE DRAWINGS

FIG. 1 shows a time-division multiple-access (TDMA) signal formatting scheme in which interference between users is minimized by allocating a sufficiently large time slot to each transmitter node.

FIG. 2 shows a TDMA signal formatting scheme in which a time division multiplex interval is divided into subintervals defining pulse positions for transmitting and receiving multiple data bits to and from each user.

FIG. 3 shows a TDMA signal formatting scheme similar to that of FIG. 2, but in which each TDMA time interval contains data pertaining to multiple users.

### DETAILED DESCRIPTION OF THE INVENTION

As depicted by way of example in the drawings, the present invention pertains to a signal formatting scheme for use in an ultra wideband (UWB) communication system used to communicate with multiple users. For example, the users may be home owners having a need to receive wideband communication data from television or Internet service providers without using underground coaxial or optical fiber cables, or satellite dish antennas.

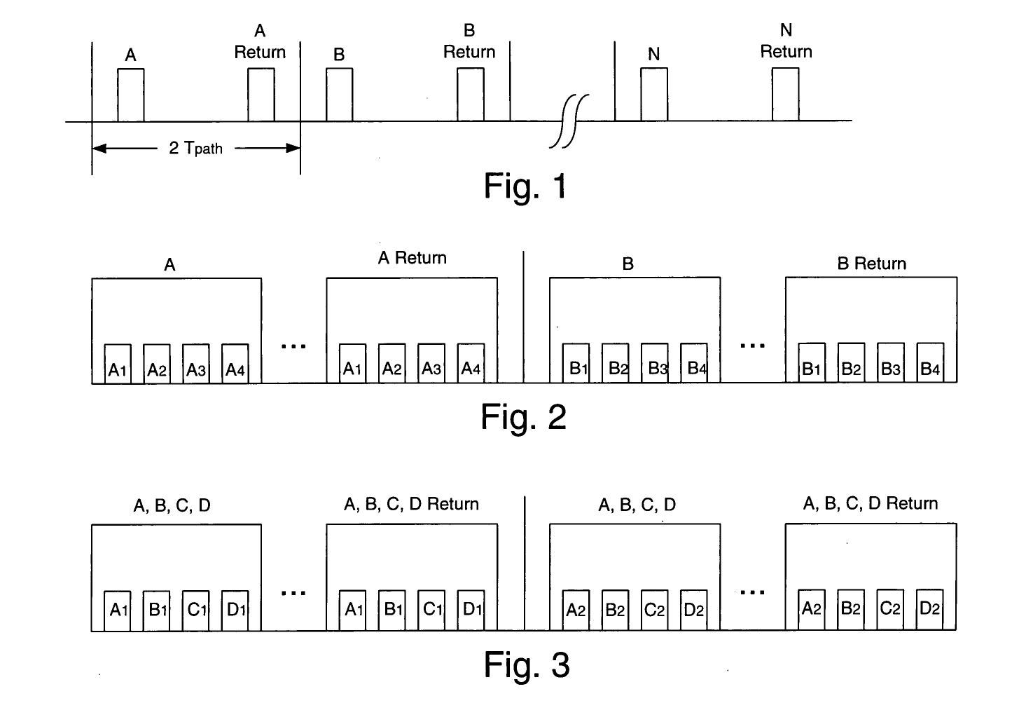

As shown, for example, in FIG. 1, UWB pulses may be transmitted periodically, in time slots allocated to different users, such as users A, B through N. Transmission of UWB pulses to users are characterized by the pulses shown at A, B and N. Depending on the distance to each user, a return pulse is transmitted back to the central transmitter/receiver, at times indicated by A Return, B Return and N Return. If the time interval between slots allocated to different users is too small, interference results between the outgoing and return pulses, or between multipath versions of these pulses.

In accordance with one aspect of the present invention, the time interval between slots is selected to be at least twice the transmission path delay (Tₚₐₜₕ) between the central site and the receiver. This ensures that a return pulse from A, for example, will not interfere with a subsequent pulse transmitted to B. Unfortunately, the data transmission rate in a scheme such as this is limited to:
M/(2Tₚₐₜₕ.N) bits per second per user, where N is the number of users and M is the number of bits conveyed with each pulse (usually one).

In accordance with another aspect of the invention, each time slot is subdivided to accommodate multiple UWB pulses, as shown in FIG. 2 and FIG. 3. In the embodiment of FIG. 2, four data bits associated with a single user (e.g., A) are encoded for transmission in a TDMA time interval. The data bits transmitted for A are designated A₁, A₂, A₃ and A₄, respectively. Later in the same time slot, a number of return pulses from user A are received at the central location. The data transmission rate is increased relative to the rate in the FIG. 1 embodiment, because a greater number of bits of data are transmitted in each TDMA time interval with a relatively small increase in the duration of the time interval.

In the embodiment of FIG. 3, data bits from different users are interleaved in each TDMA time interval. For example, a first slot is used to transmit bits A₁, B₁, C₁ and D₁ to four users A, B, C and D. Similarly, the return pulses in the first time slot the return pulses corresponding to A₁, B₁, C₁ and D₁, respectively. Similarly, a second TDMA time interval is used to transmit a second data bit to each of the users, as indicated by A₂, B₂, C₂ and D₂, and to receive return pulses from the same users. This approach allows users to receive data more frequently, and therefore at a lower latency, although the overall data rate is the same as in the FIG. 2 embodiment. It will be understood that each of the UWB pulses shown in FIGS. 1 to 3 may be either present or absent, to indicate a binary data value, or may be altered in some other way to convey information. It will be further understood that in an application with no return data from the users the TDMA intervals can be shortened to a value somewhat larger than the difference between the propagation times to the nearest and most distant users, and that an application with relatively low quantities of return data from the users can be efficiently accommodated by a sequence of several shortened intervals with no return data, followed by a long interval, or intervals, with return data.

It will be appreciated from the foregoing that the present invention represents a significant advance in the field of UWB communication systems. In particular, the invention provides for transmission of UWB pulses to multiple users in a manner that provides for more efficient sharing of the data transmission channel and minimizes interference effects. Although embodiments of the invention have been described in detail, it will be appreciated that various other embodiments and modifications fall within the intended scope of the invention. Accordingly, the invention should not be limited except as by the appended claims.

1. For use in an ultra wideband (UWB) communication system, a method for communicating binary data as a sequence of UWB pulses using time division multiple access (TDMA), the method comprising:
allocating a succession of TDMA time intervals to respective users;
transmitting a first user pulse in a first TDMA time interval;
receiving a first user return pulse in the first TDMA time interval;
transmitting a second and other user pulses in a second and subsequent respective TDMA time intervals; and
receiving a second user return pulse in the second TDMA time interval, and other user pulses in subsequent respective TDMA time intervals;
wherein each TDMA time interval is selected to be at least twice the propagation time needed to transmit data to a user, to minimize interference effects.

2. For use in an ultra wideband (UWB) communication system, a method for communicating binary data as a sequence of UWB pulses using time division multiple access (TDMA), the method comprising:
allocating a succession of TDMA time intervals to respective users;
transmitting multiple data pulses in a first TDMA time interval; and
receiving multiple return data pulses later in the same TDMA time interval.

3. A method as defined in claim 2, wherein:
the multiple data pulses are transmitted to a first user; and
the multiple return data pulses are received from the same first user.

4. A method as defined in claim 3, wherein the method further comprises:
transmitting multiple data pulses to a second user in a second TDMA time interval; and
receiving multiple return data pulses from the second user in the second TDMA time interval.

5. A method as defined in claim 2, wherein:
each TDMA time interval is selected to be at least twice the propagation time needed to transmit data to a user, to minimize interference effects.

6. For use in an ultra wideband (UWB) communication system, a method for communicating binary data as a sequence of UWB pulses using time division multiple access (TDMA), the method comprising:
allocating subintervals of each TDMA time interval to different users;
transmitting multiple data pulses in a first TDMA time interval, wherein the data pulses are addressed to separate multiple users; and
receiving multiple return data pulses later in the same TDMA time interval, wherein the return data pulses are received from separate multiple users.

7. A method as defined in claim 6, and further comprising:
transmitting multiple data pulses to multiple users in a second TDMA time interval; and
receiving multiple return data pulses later in the same second TDMA time interval.

8. A method as defined in claim 6, wherein:
each TDMA time interval is selected to be at least twice the propagation time needed to transmit data to a user, to minimize interference effects.
